(19) United States
(12) Patent Application Publication
(10) Pub. No.: US 2009/0173605 A1
(43) Pub. Date: Jul. 9, 2009

(54) KEYCAP FOR GUIDING LIGHT LATERALLY AND KEYPAD PANEL HAVING THE SAME

(76) Inventors: Chang-Li LIU, Gueishan (TW); Che-Tung Wu, Gueishan (TW)

Correspondence Address: HDLS Patent & Trademark Services, P.O. BOX 220746, CHANTILLY, VA, 20153-0746, US

(21) Appl. No.: 12/128,076

(22) Filed: May 28, 2008

(30) Foreign Application Priority Data
Jan. 9, 2008 (TW) 097200507

(51) Int. Cl. H01H 9/00

(52) U.S. Cl. 200/310

(57) ABSTRACT

A keycap is made of a light-transmitting material. The bottom of the keycap has a light-entering surface. A light-exiting surface extends from one side of the light-entering surface and intersects therewith. A connecting surface is formed between the light-entering surface and the light-exiting surface. The connecting surface is covered by a light-shielding layer. A light-reflecting surface is formed in the light-shielding layer. The light is introduced from the light-entering surface and reflected by the reflecting surface so as to project toward the light-exiting surface. The keypad panel is constituted of the above-mentioned keycap.

### RELATED APPLICATION

U.S. patent application Ser. No. 11/947,821 filed on Nov. 30, 2007 is submitted as related application.

### BACKGROUND OF THE INVENTION

1. Field of the Invention

The present invention relates to a hardware operating interface, and in particular to a keypad panel that can be applied to an electronic product, such as a mobile phone or personal digital assistant (PDA).

2. Description of Prior Art

A keyboard is one of the primary input means for an electronic device. Each key of a keypad panel of the keyboard is provided thereon with corresponding numerals, characters, phonetic symbols, roots for an input method and/or various functional icons, so that a user can input correct data or perform various functions of the electronic device. Therefore, for an electronic device, the keyboard acts as an important human/machine interface.

Since the light may be sometimes insufficient for a working environment of an electronic device, the keypad panel of a common keyboard is usually provided with a light source to generate a little or sufficient light for recognition, so that the user can still operate the keypad panel even though the light is dim. Although the displaying area can be illuminated directly via an underneath light source so as to generate a better illumination effect, the direct illumination may be harsh to the user's eyes. Especially in a dark environment, a light emitted suddenly may be so harsh to the user's eyes if he/she looks at the light, which will affect the vision of the user temporarily.

According to the above, in order to overcome the drawbacks of prior art, the inventor proposes the present invention based on his researches and expert experience.

### SUMMARY OF THE INVENTION

The present invention is to provide a keycap for guiding light laterally and a keypad panel having the keycap, in which a lateral light is provided to illuminate a keypad without making the light to irradiate the user's eyes directly. In this way, the hurt to the user's eyes can be reduced or eliminated.

The present invention provides a keycap for guiding light laterally, which is made of a light-transmitting material. The bottom of the keycap has a light-entering surface A light-exiting surface extends from one side of the light-entering surface and intersects therewith. A connecting surface is formed between the light-entering surface and the light-exiting surface. The connecting surface is covered by a light-shielding layer. A light-reflecting surface is formed in the light-shielding layer. Via this arrangement, the light is introduced from the light-entering surface and reflected by the light-reflecting surface to project toward the light-exiting surface. Therefore, an effect of guiding light laterally can be achieved.

The present invention also provides a keypad panel for guiding light laterally, which includes an opaque layer and a keycap assembly. The opaque layer is an opaque thin sheet, and is provided thereon with a plurality of recognition regions. A corresponding keycap hole is provided adjacent to one side of each recognition region. The keycap assembly has a carrier located underneath the opaque layer, and a plurality of keycaps protruding from the carrier. Each of the keycaps is arranged in the corresponding keycap hole to protrude from the surface of the opaque layer. Via the above arrangement, a keypad panel can be formed to achieve the desired effects.

### BRIEF DESCRIPTION OF THE DRAWINGS

FIG. 1 is an exploded perspective view of the present invention;

FIG. 2 is an assembled perspective view of the present invention;

FIG. 3 is an enlarged cross-sectional view taken along the line 3-3 in FIG. 2;

FIG. 4 is a partially cross-sectional view showing the present invention being assembled with a telecommunication module;

FIG. 5 is a schematic view showing the action of FIG. 4;

FIG. 6 is an exploded perspective view showing another embodiment of the present invention;

FIG. 7 is a partially cross-sectional view showing another embodiment of the present invention being assembled with a telecommunication module;

FIG. 8 is a schematic view showing the present invention being used in a mobile phone;

FIG. 9 is a schematic view showing the present invention being used in a personal digital assistant; and

FIG. 10 is a schematic view showing the present invention being used in an automobile control interface.

### DETAILED DESCRIPTION OF THE INVENTION

In order to make the Examiner to better understand the characteristics and technical contents of the present invention, a detailed description relating thereto will be made with reference to the accompanying drawings. However, the drawings are illustrative only, but not used to limit the scope of the present invention.

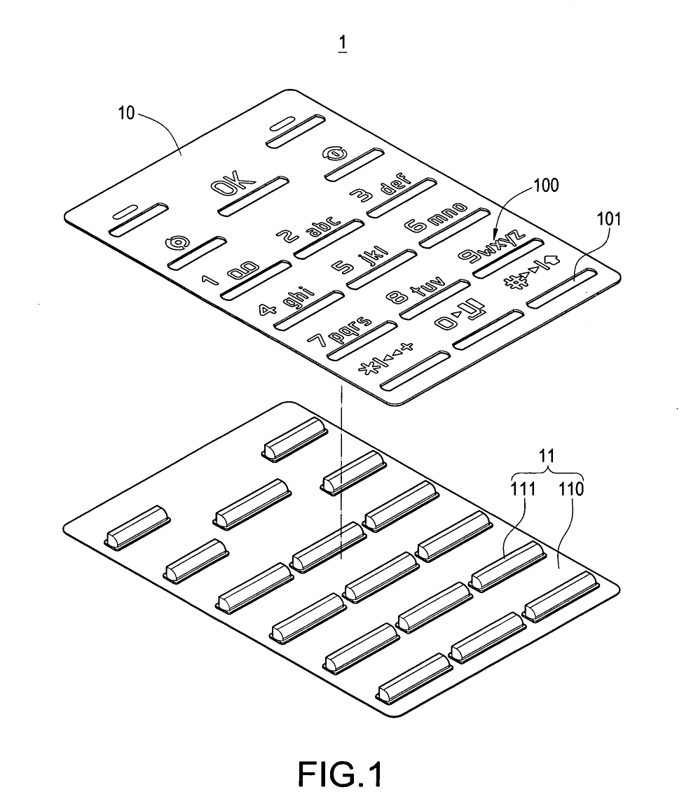

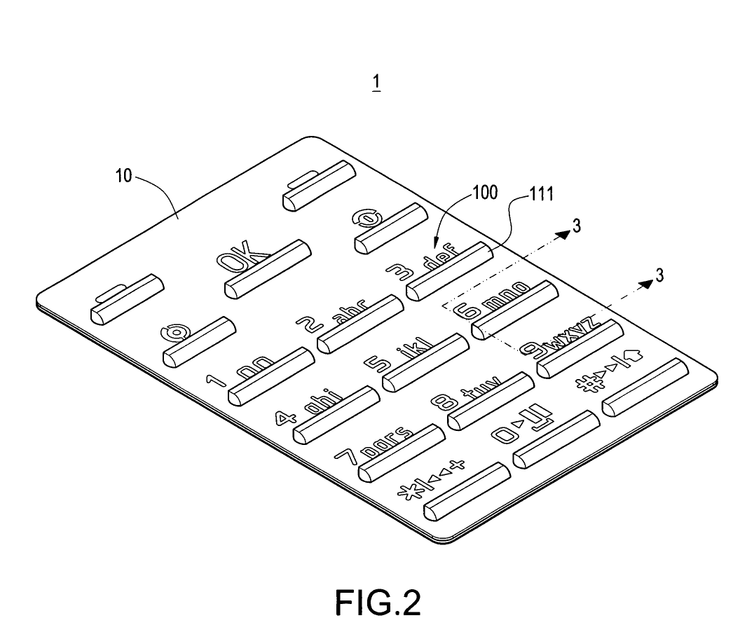

FIGS. 1 and 2 are an exploded perspective view and an assembled perspective view of the present invention respectively. The present invention provides a keycap for guiding light laterally and a keypad panel. The keypad panel 1 includes an opaque layer 10 and a keycap assembly 11.

The opaque layer 10 is a thin sheet made of an opaque material such as a circuit board, electronic ink, wood, cork, leather, metal or the like. Via a printing, etching or an electronic ink developing process, an upper surface of the opaque layer 10 is provided with recognition regions 100 constituted of numerals, characters, phonetic symbols, roots for an input method and/or various functional icons. A corresponding keycap hole 101 is provided adjacent to one side of each recognition region 100 on the opaque layer 10. In the illustrated embodiment of the present invention, when the opaque layer 10 is in an upright position, each of the keycap holes 101 is located below the corresponding recognition region 100. Of course, the possible arrangement is not limited thereto.

The keycap assembly 11 is located on a lower surface of the opaque layer 10. The keycap assembly 11 has a carrier 110 that is overlapped in parallel with the surface of the opaque layer 10, and a plurality of keycaps 111 protruding from the carrier 110. Each of the keycaps 111 is arranged to correspond to an associated recognition region 100, and penetrates through the corresponding keycap hole 101 to protrude from the surface of the opaque layer 10, so that a user can press the keycap.

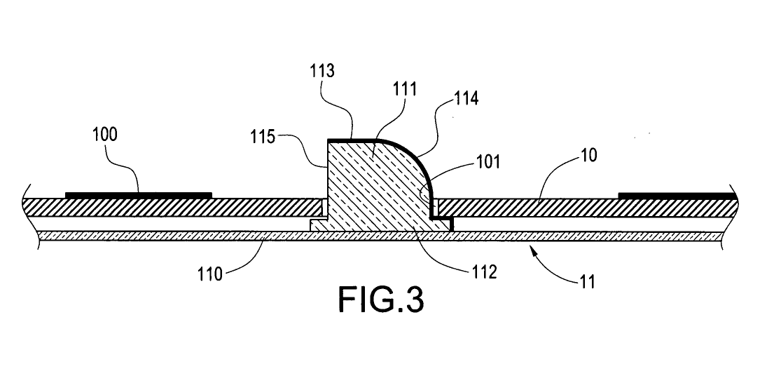

As shown in FIG. 3, each keycap 111 is made of a light-transmitting material such as acryl, plastic or PC, and can be colored as desired. Each keycap 111 has a light-entering surface 112 that is located in the bottom thereof and adhered on the carrier 110. A light-exiting surface 115 extends from one side of the light-entering surface 112 and intersects therewith. A connecting surface 114 is formed between the light-entering surface 112 and the light-exiting surface 115. The connecting surface 114 is covered by a light-shielding layer 113. A light-reflecting surface is formed in the light-shielding layer 113. The light-shielding layer 113 can be attached to the connecting surface 114 via an electroplating process. Since the light-exiting surface 115 is not covered by the light-shielding layer 113, it cannot shield the light. After the keycap 111 penetrates through the corresponding keycap hole 101, the light-exiting surface 115 of the keycap 111 corresponds to an associated recognition region 100, thereby projecting the light onto the recognition region 100.

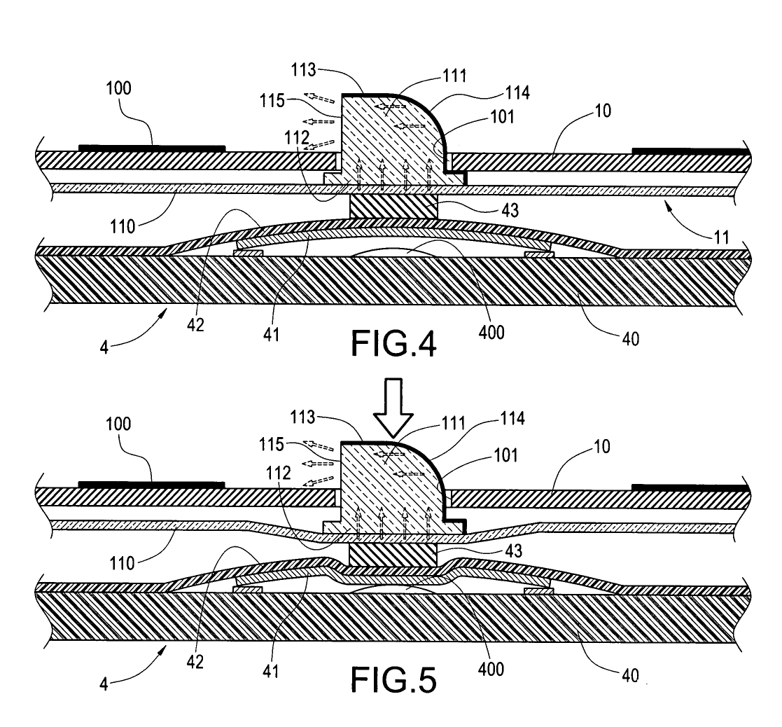

Please refer to FIG. 4. The underside of the key panel 1 can be further assembled with a telecommunication module 4. The telecommunication module 4 has a flexible printed circuit board 40. The circuit board 40 is provided thereon with a plurality of contacting points 400. Each of the contacting points 400 corresponds to each keycap 111 of the keypad module in a vertical direction. Each of the contacting points 400 is provided thereon with a corresponding metal sheet 41. The circuit board 40 is provided thereon with an elastic film 42 for covering each metal sheet 41. A plurality of protrusions 43 is provided between the elastic film 42 and the keypad module. Each protrusion 43 is located to correspond to the underside of each keycap 111 of the keypad module.

Please refer to FIG. 5. When the user applies a downward force to press any keycap 111, the corresponding protrusion 43 is pressed to bias downwardly the elastic film 42 and the metal sheet 41 so as to touch the corresponding contacting point 400, thereby achieving an input action. At this time, via the pressing action of the user, the light emitted from a built-in light source is introduced from the light-entering surface 112 of the keycap 111. After being reflected by the reflecting surface of the light-shielding layer 113, the light is projected toward the light-exiting surface 115 and onto the recognition region 100, thereby illuminating the recognition region 100. In this way, the user can recognize the completion of the pressing action.

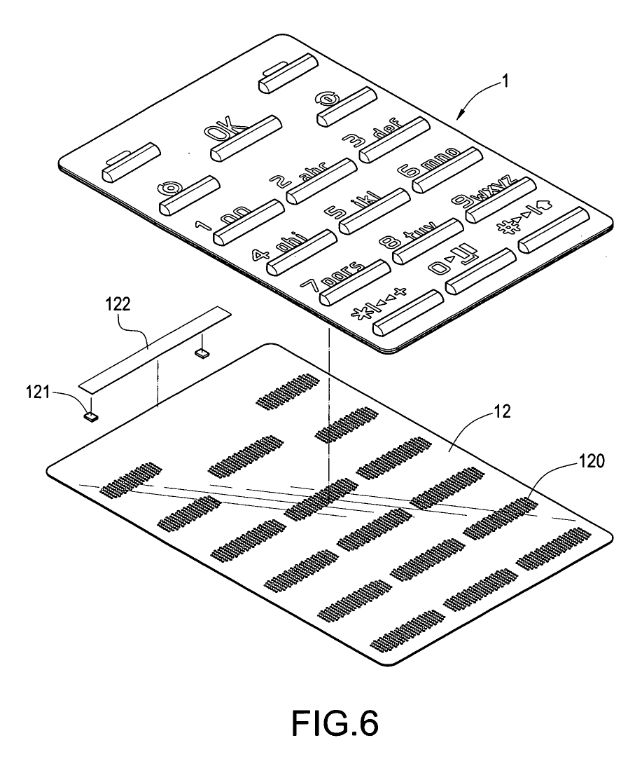

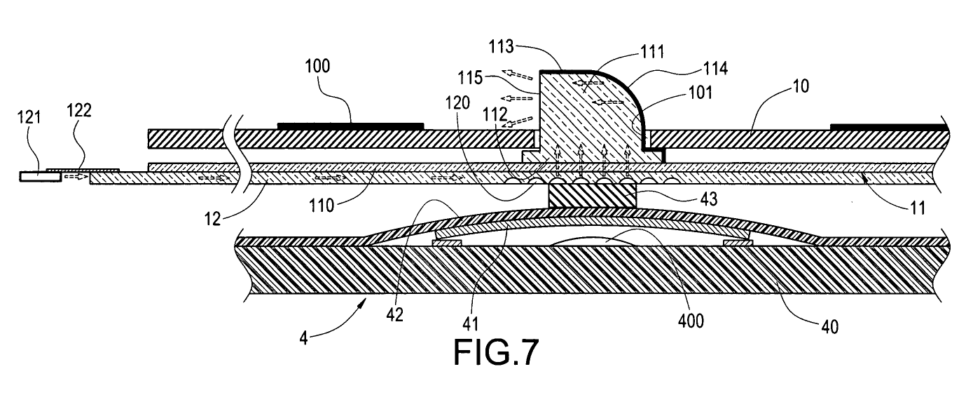

Further, as shown in FIGS. 6 and 7, the keypad panel 1 further includes a light-guiding layer 12. The light-guiding layer 12 is located between the keypad panel 1 and the telecommunication module 4, and is adhered to the underside of the carrier 110 of the keypad panel 1. The light-guiding layer 12 is provided thereon with a plurality of sections of light-guiding structures 120. Each section of the light-guiding structures 120 corresponds to a keycap 111 of the keypad panel 1. One side of the light-guiding layer 12 is provided externally with light-emitting diodes (LED) 121. The LED 121 is connected to the light-guiding layer 12 via a flexible flat cable, thereby emitting light after being supplied with electricity. The LED 121 projects the light laterally from the light-guiding layer 12 on the light-guiding structures 120. Then, the light-guiding structures 120 reflect the light onto the corresponding keycap 111, thereby illuminating the recognition region 100 of the opaque layer 10 as mentioned in the previous embodiment.

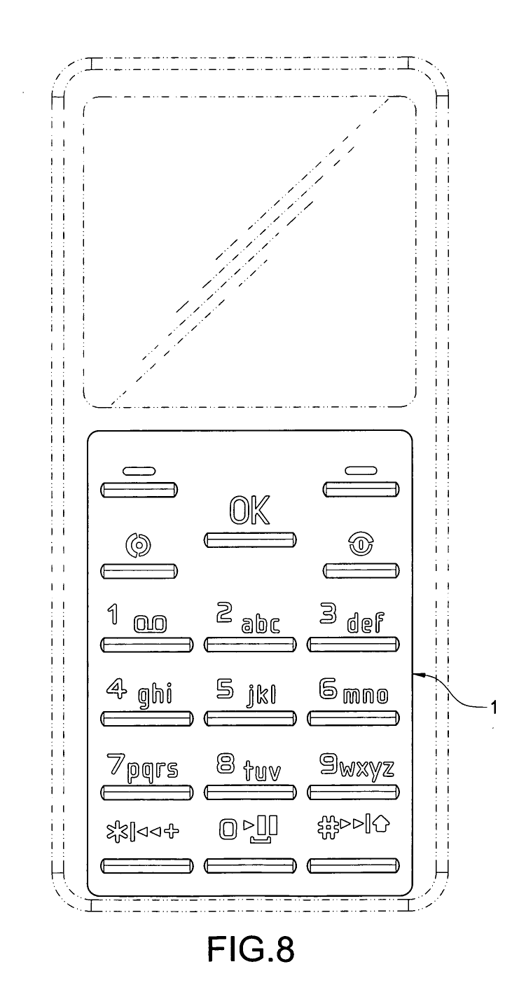

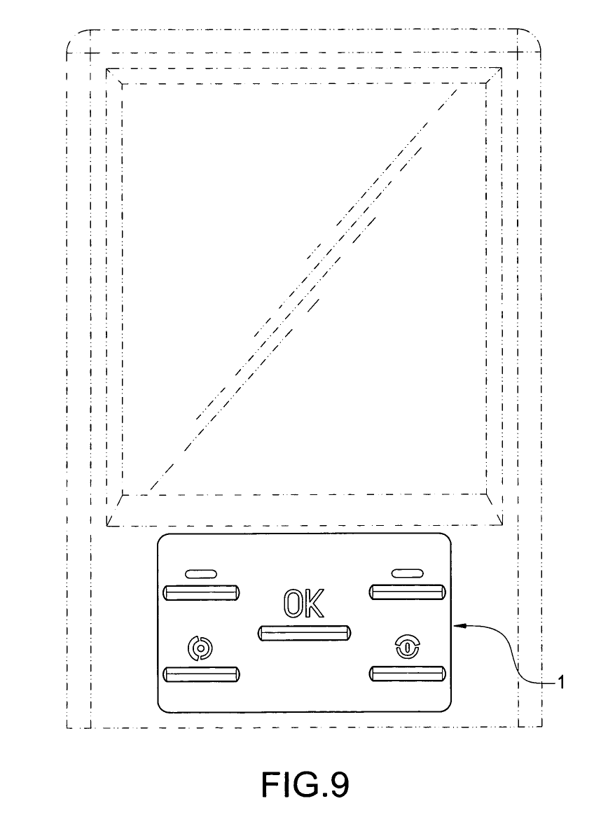

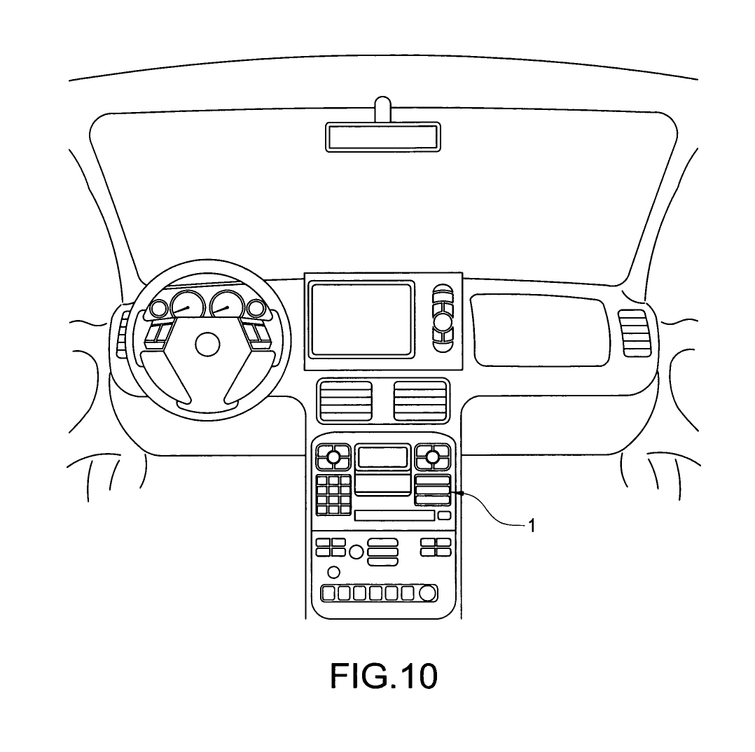

Further, please refer to FIGS. 8 to 10. The keypad panel for guiding light laterally according to the present invention can be applied at least to a mobile phone, a personal digital assistant (PDA) and an automobile control interface. Of course, the application is not limited to the above cases, and the present invention can be applied to other human/machine operating interfaces.

According to the above, the present invention really achieves the desired objects and solves the drawbacks of prior art. Further, the present invention has novelty and inventive steps, and thus conforms to the requirements for a utility model patent.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A keycap for guiding light laterally, made of a light-transmitting material and comprising:
a light-entering surface provided on the bottom of the keycap;
a light-exiting surface extending from one side of the light-entering surface and intersecting therewith;
a connecting surface formed between the light-entering surface and the light-exiting surface;
a light-shielding layer covering the connecting surface; and
a light-reflecting surface formed in the light-shielding layer,
whereby the light is introduced from the light-entering surface and reflected by the reflecting surface so as to project toward the light-exiting surface.

2. The keycap for guiding light laterally according to claim 1, wherein the light-transmitting material comprises acryl.

3. The keycap for guiding light laterally according to claim 1, wherein the light-transmitting material comprises plastic.

4. The keycap for guiding light laterally according to claim 1, wherein the light-transmitting material comprises PC.

5. The keycap for guiding light laterally according to claim 1, wherein the light-transmitting material is colored.

6. The keycap for guiding light laterally according to claim 1, wherein the light-shielding layer is adhered to the connecting surface via an electroplating process.

7. A keypad panel for guiding light laterally, comprising:
an opaque layer made of an opaque thin sheet, the opaque layer being provided thereon with a plurality of recognition regions, a corresponding keycap hole being provided adjacent to one side of each recognition region; and
a keycap assembly having a carrier located underneath the opaque layer, and a plurality of keycaps protruding from the carrier, each of the keycaps being arranged in the corresponding keycap hole to protrude from the surface of the opaque layer;
wherein each of the keycaps is made of a light-transmitting material, the bottom of the keycap has a light-entering surface, a light-exiting surface extends from one side of the light-entering surface and intersects therewith, a connecting surface is formed between the light-entering surface and the light-exiting surface, the connecting surface is covered by a light-shielding layer, a light-reflecting surface is formed in the light-shielding layer, whereby the light is introduced from the light-entering surface and reflected by the reflecting surface so as to project toward the light-exiting surface.

8. The keypad panel for guiding light laterally according to claim 7, wherein the opaque layer is made of a circuit board, electronic ink, wood, cork, leather or metal.

9. The keypad panel for guiding light laterally according to claim 7, wherein the recognition regions are constituted of numerals, characters, phonetic symbols, roots for an input method and/or various functional icons.

10. The keypad panel for guiding light laterally according to claim 7, wherein the keycap hole is located below the corresponding recognition region.

11. The keypad panel for guiding light laterally according to claim 7, wherein the keycaps are made of acryl, plastic or PC.

12. The keypad panel for guiding light laterally according to claim 7, wherein the keycaps are colored.

13. The keypad panel for guiding light laterally according to claim 7, wherein the light-shielding layer is adhered to the connecting surface via an electroplating process.

14. The keypad panel for guiding light laterally according to claim 7, further comprising a light-guiding layer, the light-guiding layer being adhered to the underside of the carrier of the keycap assembly.

15. The keypad panel for guiding light laterally according to claim 14, wherein the light-guiding layer is provided thereon with a plurality of sections of light-guiding structures, each section of the light-guiding structures corresponds to each keycap, one side of the light-guiding layer is provided externally with light-emitting diodes (LED), thereby projecting the light toward the light-guiding structures.

16. The keypad panel for guiding light laterally according to claim 15, wherein the LED is connected to the light-guiding layer via a flexible flat cable.

17. The keypad panel for guiding light laterally according to claim 14, further comprising a telecommunication module, the telecommunication module having a circuit board located underneath the light-guiding layer, the circuit board being provided thereon with a plurality of contacting points, each of the contacting points corresponds to each keycap.

18. The keypad panel for guiding light laterally according to claim 17, wherein each contacting point of the telecommunication module is provided thereon with a metal sheet, the circuit board is provided thereon with an elastic film for covering each metal sheet, a plurality of protrusions is provided between the elastic film and the keypad module, each protrusion is located to correspond to the underside of each keycap.

19. The keypad panel for guiding light laterally according to claim 7, further comprising a telecommunication module, the telecommunication module having a circuit board located underneath the carrier, the circuit board being provided thereon with a plurality of contacting points, each of the contacting points corresponds to each keycap.

20. The keypad panel for guiding light laterally according to claim 19, wherein each contacting point of the telecommunication module is provided thereon with a metal sheet, the circuit board is provided thereon with an elastic film for covering each metal sheet, a plurality of protrusions is provided between the elastic film and the keypad module, each protrusion is located to correspond to the underside of each keycap.
